(19) United States
(12) Patent Application Publication
(10) Pub. No.: US 2008/0204207 A1
(43) Pub. Date: Aug. 28, 2008

(54) Two-Way Automotive Remote Controller

(76) Inventors: James P. Speers, St., Albert (CA); Byung Woo Min, Sunland, CA (US)

Correspondence Address: PARK LAW FIRM, 3255 WILSHIRE BLVD, SUITE 1110, LOS ANGELES, CA, 90010, US

(21) Appl. No.: 11/679,617

(22) Filed: Feb. 27, 2007

(51) Int. Cl. B60R 25/10

(52) U.S. Cl. 340/426.13

(57) ABSTRACT

A two-way automotive remote control system for a vehicle having a data bus includes a factory enhancement module, a wire harness adapted to connect the factory enhancement module with the data bus of the vehicle, an antenna, and a remote communicating with the factory enhancement module electronically. The factory enhancement module has a data bus interface, a microcontroller, an antenna interface, and a power supply, and activates the remote in predetermined situations of the vehicle. The data bus interface of the factory enhancement module and the antenna interface are monitored continually. The factory enhancement module accepts and decodes the outputs from the alarm system of the vehicle through the data bus interface. The outputs from the alarm system includes messages according to a predetermined communication standard, which includes J1850. The factory enhancement module accepts and decodes predetermined command messages from the remote in an electromagnetic wave transmission.

### BACKGROUND OF THE INVENTION

The present invention relates to a two-way automotive remote controller. More particularly, this invention relates to a two-way automotive remote controller, which communicates information with the vehicle and is able to be activated by the alarm system of the vehicle.

Many of today's new vehicles come with remote keyless entry and alarm options. Some vehicles are now coming equipped with remote car starters as well. It is great to be able to start the car while sipping a cup of coffee in the living room and hop into the already-warmed car in a harsh winter. Many other remote functions are installed in default.

However, the factory units have limited range and do not provide feedback to the user. That is, the vehicles do not provide two-way verification that vehicle has responded to the remote button press.

In particular, the regular remote keyless entry and alarm systems cannot get rid of the fretfulness of drivers obsessed with the possibility of automobile security breach.

Also, the remote keyless entry or alarm system with full power is usually very expensive option for customers. On some models, there is no factory-installed remote keyless entry system altogether from the start.

Accordingly, a need for an two-way automotive remote controller has been present for a long time considering the widespread concerns among drivers. This invention is directed to solve these problems and satisfy the long-felt need.

### SUMMARY OF THE INVENTION

An objective of the invention is to provide a two-way automotive remote controller, which is installed easily.

Another objective of the invention is to provide a two-way automotive remote controller, which is able to extend the functions of factory-installed remote keyless entry or alarm system.

Still another objective of the invention is to provide a two-way automotive remote controller, in which a remote can be activated by the vehicle, telling when the vehicle has been started or stopped, especially in emergency at the vehicle.

A two-way automotive remote control system for a vehicle having a data bus includes a factory enhancement module (FEM), a wire harness, an antenna, and a remote.

The factory enhancement module has a data bus interface, a microcontroller, an antenna interface, and a power supply. The wire harness is adapted to connect the factory enhancement module with the data bus of the vehicle. The remote communicates with the factory enhancement module electronically.

The factory enhancement module activates the remote in predetermined situations of the vehicle. The data bus interface of the factory enhancement module and the antenna interface are monitored continually as long as the system is on.

The factory enhancement module accepts and decodes the outputs from the alarm system of the vehicle through the data bus interface connected by the wire harness. The outputs from the alarm system of the vehicle includes messages according to a predetermined communication standard. The predetermined communication standard includes J1850, an automotive local area network in the car standardized by SAE (Society of Automotive Engineers).

The factory enhancement module sends a predetermined message to the remote on receiving predetermined signals including an alarm message from the alarm system of the vehicle, a signal for detecting the hood's opening in a locked state of the vehicle, a signal for detecting the door's opening in a locked state of the vehicle. The remote issues an alarm on receiving the predetermined signals from the factory enhancement module.

The factory enhancement module accepts and decodes predetermined command messages from the remote in an electromagnetic wave transmission. The command messages include commands for locking all doors, unlocking the driver's door, unlocking all doors, locating the vehicle, issuing a panic alarm, opening a trunk, opening a window, and consulting a vehicle status. The factory enhancement module performs the actions following the commands and transmits a verification to the remote, and updates the status of vehicle.

The factory enhancement module accepts and decodes the messages according to a predetermined communication standard from the alarm system of the vehicle through the data bus interface, and issues an alarm to the remote, disarms the situations, and then transmits a verification to the remote.

The messages according to a predetermined communication standard include the information on an alarm signal, an opened door signal, an opened hood signal, a locked vehicle signal, a lock signal, an unlock signal, and a disarm signal.

The factory enhancement module activates the horn and the park lights and sends an alarm message to the remote on detecting a locked vehicle signal along with the alarm signal, the opened door signal, or the opened hood signal.

The factory enhancement module sends the disarm message to the remote on detecting the disarm signal, and goes back to the continual monitoring of the data bus interface of the factory enhancement module and the antenna interface.

The factory enhancement module disables the alarm state after a predetermined period, records an alarm condition, and goes back to the continual monitoring of the data bus interface of the factory enhancement module and the antenna interface.

The factory enhancement module transmits the message to the remote, updates the vehicle status, and goes back to the continual monitoring of the data bus interface of the factory enhancement module and the antenna interface, on detecting the lock signal or the unlock signal along with the absence of the alarm signal, the opened door signal, or the opened hood signal.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic block diagram showing a two-way automotive remote controller;

FIG. 2 is a block diagram of a factory enhancement module;

FIG. 3 is a flow chart of continual monitoring;

FIG. 4 is a flow chart of processing remote command;

FIG. 5 is a flow chart of processing J1850 messages in factory alarm mode; and

FIG. 6 is a flow chart of processing J1850 messages in full alarm mode.

### DETAILED DESCRIPTION OF THE INVENTION

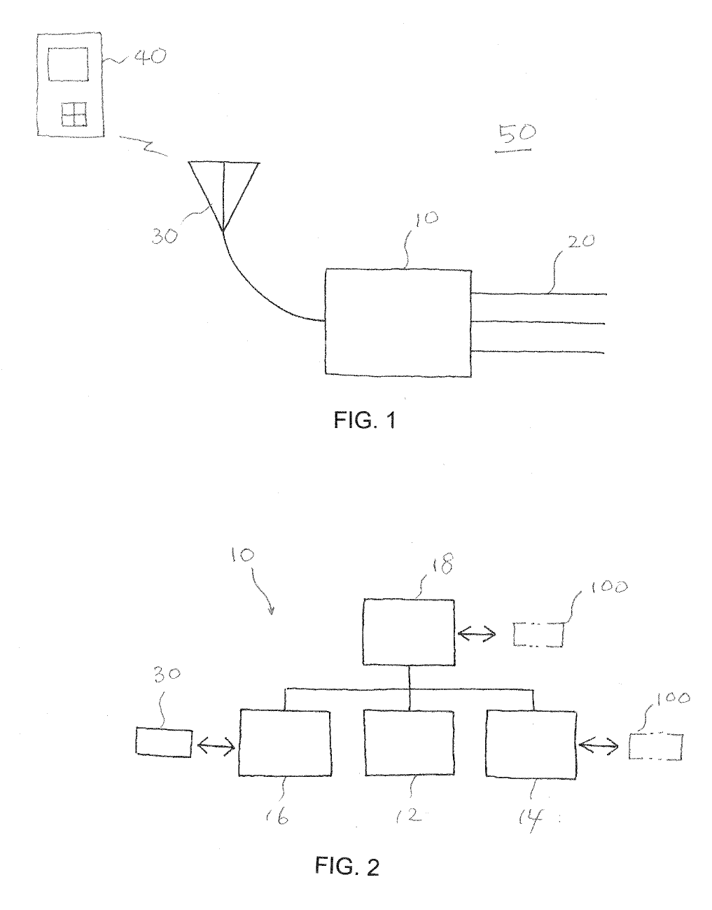

FIGS. 1 and 2 show block diagrams of a two-way automotive remote controller 50.

The two-way automotive remote control system 50 for a vehicle 100 having a data bus includes a factory enhancement module (FEM) 10, a wire harness 20, an antenna 30, and a remote 40.

The factory enhancement module 10 has a data bus interface 14, a microcontroller 12, an antenna interface 16, and a power supply 18. The wire harness 20 is adapted to connect the factory enhancement module 10 with the data bus of the vehicle 100. The remote 40 communicates with the factory enhancement module 10 electronically.

The wire harness 20 is preferably three-wire harness, and includes leads for data bus, power, preferably DC 12V, and electrical ground.

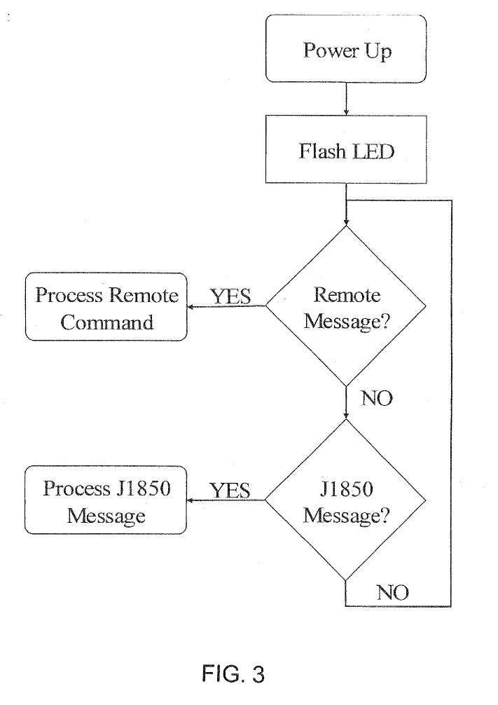

The factory enhancement module 10 activates the remote 40 in predetermined situations of the vehicle 100. The data bus interface 14 of the factory enhancement module 10 and the antenna interface 16 are monitored continually as long as the controller 50 is on as shown in FIG. 3.

The factory enhancement module 10 accepts and decodes the outputs from the alarm system of the vehicle 100 through the data bus interface 14 connected by the wire harness 20. The outputs from the alarm system of the vehicle 100 include messages according to a predetermined communication standard. The predetermined communication standard includes J1850, an automotive local area network in the car standardized by SAE (Society of Automotive Engineers).

The factory enhancement module 10 sends a predetermined message to the remote 40 on receiving predetermined signals including an alarm message from the alarm system of the vehicle 100, a signal for detecting the hood's opening in a locked state of the vehicle 100, a signal for detecting the door's opening in a locked state of the vehicle 100. The remote 40 issues an alarm on receiving the predetermined signals from the factory enhancement module 10.

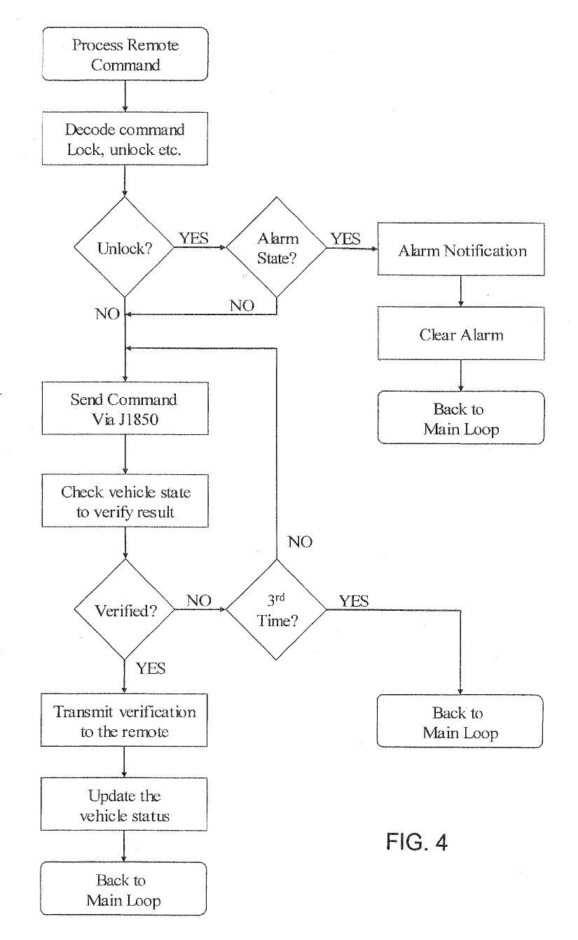

The factory enhancement module 10 accepts and decodes predetermined command messages from the remote 40 in an electromagnetic wave transmission. The command messages include commands for locking all doors, unlocking the driver's door, unlocking all doors, locating the vehicle, issuing a panic alarm, opening a trunk, opening a window, and consulting a vehicle status. The factory enhancement module 10 performs the actions following the commands and transmits a verification to the remote 40, and updates the status of vehicle 100 as shown in FIG. 4.

The factory enhancement module 10 accepts and decodes the messages according to a predetermined communication standard from the alarm system of the vehicle 100 through the data bus interface 14, and issues an alarm to the remote 40, disarms the situations, and then transmits a verification to the remote 40.

The messages according to a predetermined communication standard include the information on an alarm signal, an opened door signal, an opened hood signal, a locked vehicle signal, a lock signal, an unlock signal, and a disarm signal.

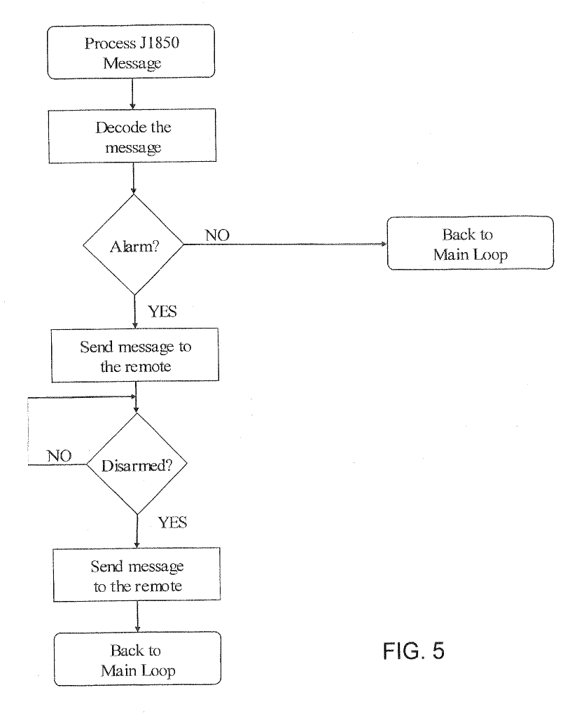

FIG. 5 shows a flow chart of processing J1850 messages in a factory alarm mode.

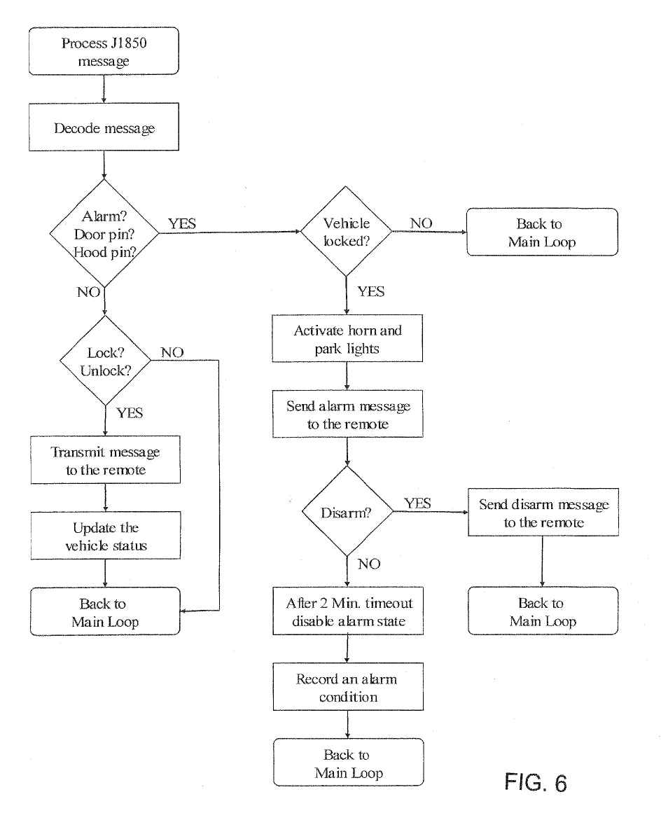

FIG. 6 shows a flow chart of processing J1850 messages in a full alarm mode of the invention.

The factory enhancement module 10 activates the horn and the park lights and sends an alarm message to the remote 40 on detecting a locked vehicle signal along with the alarm signal, the opened door signal, or the opened hood signal.

The factory enhancement module 10 sends the disarm message to the remote 40 on detecting the disarm signal, and goes back to the continual monitoring of the data bus interface 14 of the factory enhancement module 10 and the antenna interface 16.

The factory enhancement module 10 disables the alarm state after a predetermined period, records an alarm condition, and goes back to the continual monitoring of the data bus interface 14 of the factory enhancement module 10 and the antenna interface 16.

The factory enhancement module 10 transmits the message to the remote 40, updates the vehicle status, and goes back to the continual monitoring of the data bus interface 14 of the factory enhancement module 10 and the antenna interface 16, on detecting the lock signal or the unlock signal along with the absence of the alarm signal, the opened door signal, or the opened hood signal.

The two-way automotive remote controller 50 provides a car owner with an easy upgrade to the regular remote keyless entry and alarm system. It provides a two-way communications between the vehicle 100 and the remote 40, enhanced capabilities, and more flexible programming. The factory enhancement module 10 only requires three direct connections to the vehicle 100; power, ground, and data. That is, the module 50 can be installed very quickly into the vehicle 100.

Using the controller 50, it is possible to program certain operating options of the vehicle 100 according to the end user's needs. For example, the length of the horn honk is settable including the option to disable horn honk. Also, the user can enable or disable the driver's door priority.

Furthermore, the two-way automotive remote controller 50 can provide some models of vehicles with the functionality of factory remote keyless entry and more.

For vehicles with factory alarm only, the two-way automotive remote controller 50 provides increased range of the electromagnetic communication, two-way communications, and the ability for the vehicle 100 to page the owner and notify her or him of an alarm condition. If the user is out of range or doesn't respond to clear the alarm state the factory enhancement module 10 will notify the user the next time he unlocks the vehicle 100.

The two-way automotive remote controller 50 also provides functionality such as car finder, panic, trunk/glass opening, and vehicle status. Vehicle status is not possible with a factory system only since the vehicle 100 cannot transmit signal to the user's remote 40.

The two-way automotive remote controller 50 also provides programming modes for the remotes 40, horn honk timing, park light settings, door and hood pin detection, driver door priority, and vehicle selection.

The programming of the remotes includes the steps of:

a) Within 3 seconds turn the key ON-OFF-ON-OFF-ON the FEM will monitor this via data bus;

b) Press and hold the PROGRAM button on the antenna, after 5 seconds the horn will honk twice and the park lights will go on;

c) Continue to hold the PROGRAM button until the horn honks 5 times and the park lights go out. At this point all stored remote data is erased;

d) Press the LOCK button on each of the remotes to be programmed in, this must be done within 5 seconds. Up to three remotes may be programmed in; and

e) After 5 seconds the unit returns to normal operation.

The programming of horn honk timing includes the steps of:

a) Within 3 seconds turn the key ON-OFF-ON-OFF-ON the FEM will monitor this via data bus;

b) Press and release the PROGRAM button on the antenna once;

c) Park lights will flash and the horn will honk once; and

d) The user has 5 seconds to press a button on the remote to set the horn honk timing. Each time a button is pressed the horn will honk to demonstrate the sound level. More than one button can be hit within the five seconds, the unit will use the value of the last button pressed before the 5 second timeout. (LOCK: horn off, UNLOCK: short pulse 5 mS, *: medium pulse 10 mS, #: long pulse 20 mS) The default setting is medium pulse 10 mS.

The programming of the park light settings includes the steps of:

(a) Within 3 seconds turn the key ON-OFF-ON-OFF-ON the FEM will monitor this via data bus;

(b) Press and release the PROGRAM button on the antenna twice;

(c) Park lights will flash and the horn will honk twice; and

(d) The user has 5 seconds to press a button on the remote to set the park lights. More than one button can be hit within the five seconds, the unit will use the value of the last button pressed before the 5 second timeout. (LOCK: park lights disabled, horn honks once, UNLOCK: park lights enabled, horn honks twice, *: no effect) The default setting is park lights enabled.

The programming of the door and hood pin detection includes the steps of:

(a) Within 3 seconds turn the key ON-OFF-ON-OFF-ON the FEM will monitor this via data bus;

(b) Press and release the PROGRAM button on the antenna three times;

(c) Park lights will flash and the horn will honk three times; and

(d) The user has 5 seconds to press a button on the remote to set door and hood pin detection. More than one button can be hit within the five seconds, the unit will use the value of the last button pressed before the 5 second timeout. (LOCK: ignore, look only for factory alarm message, horn honks once, UNLOCK: look for hood pin, door pin, and alarm horn honks twice, *: no effect)

The default setting is to look for the hood pin, door pin, and alarm messages on the bus.

The programming of the drivers door priority includes the steps of:

(a) Within 3 seconds turn the key ON-OFF-ON-OFF-ON the FEM will monitor this via data bus;

(b) Press and release the PROGRAM button on the antenna four times;

(c) Park lights will flash and the horn will honk four times; and

(d) The user has 5 seconds to press a button on the remote to select driver's door priority unlock. If this feature is ON the user can unlock just the driver's door with one press of the UNLOCK button, a second UNLOCK button press within 3 seconds will unlock all the doors. If the feature is OFF the first UNLOCK button press will unlock all doors. More than one button can be hit within the five seconds, the unit will use the value of the last button pressed before the 5 second timeout. (LOCK: OFF, horn honks once, UNLOCK: ON, horn honks twice, *: no effect, #: no effect) The default setting is ON.

The programming of the vehicle selection includes the step in which the type of vehicle, and the associated codes, will be selected using DIP switches.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A two-way automotive remote control system for a vehicle having a data bus comprising:
a) a factory enhancement module having a data bus interface, a microcontroller, and an antenna interface;
b) a wire harness adapted to connect the factory enhancement module with the data bus of the vehicle;
c) an antenna; and
d) a remote communicating with the factory enhancement module electronically.

2. The two-way automotive remote control system of claim 1, wherein the factory enhancement module activates the remote in predetermined situations of the vehicle.

3. The two-way automotive remote control system of claim 1, wherein the data bus interface of the factory enhancement module and the antenna interface are monitored continually.

4. The two-way automotive remote control system of claim 1, wherein the factory enhancement module accepts and decodes the outputs from the alarm system of the vehicle through the data bus interface connected by the wire harness.

5. The two-way automotive remote control system of claim 4, wherein the outputs from the alarm system of the vehicle comprises messages according to a predetermined communication standard.

6. The two-way automotive remote control system of claim 5, wherein the predetermined communication standard comprises J1850.

7. The two-way automotive remote control system of claim 5, wherein the factory enhancement module sends a predetermined message to the remote on receiving predetermined signals.

8. The two-way automotive remote control system of claim 7, wherein the predetermined signals comprise an alarm message from the alarm system of the vehicle.

9. The two-way automotive remote control system of claim 7, wherein the predetermined signals comprise a signal for detecting the hood's opening in a locked state of the vehicle.

10. The two-way automotive remote control system of claim 7, wherein the predetermined signals comprise a signal for detecting the door's opening in a locked state of the vehicle.

11. The two-way automotive remote control system of claim 7, wherein the remote issues an alarm on receiving the predetermined signals from the factory enhancement module.

12. The two-way automotive remote control system of claim 5, wherein the factory enhancement module accepts and decodes predetermined command messages from the remote in an electromagnetic wave transmission.

13. The two-way automotive remote control system of claim 12, wherein the command messages comprise commands for a) locking all doors;
b) unlocking the driver's door;
c) unlocking all doors;
d) locating the vehicle;
e) issuing a panic alarm;
f) opening a trunk;
g) opening a window; and
h) consulting a vehicle status.

14. The two-way automotive remote control system of claim 13, wherein the factory enhancement module performs the actions following the commands and transmits a verification to the remote, and updates the status of vehicle.

15. The two-way automotive remote control system of claim 5, wherein the factory enhancement module accepts and decodes the messages according to a predetermined communication standard from the alarm system of the vehicle through the data bus interface.

16. The two-way automotive remote control system of claim 15, wherein the factory enhancement module issues an alarm to the remote, disarms the situations, and then transmits a verification to the remote.

17. The two-way automotive remote control system of claim 15, wherein the messages according to a predetermined communication standard comprise the information on:
a) an alarm signal;
b) an opened door signal;
c) an opened hood signal;
d) a locked vehicle signal;
e) a look signal;
f) an unlock signal; and
g) a disarm signal.

18. The two-way automotive remote control system of claim 17, wherein the factory enhancement module activates the horn and the park lights and sends an alarm message to the remote on detecting a locked vehicle signal along with the alarm signal, the opened door signal, or the opened hood signal.

19. The two-way automotive remote control system of claim 18, wherein the factory enhancement module sends the disarm message to the remote on detecting the disarm signal, and goes back to the continual monitoring of the data bus interface of the factory enhancement module and the antenna interface.

20. The two-way automotive remote control system of claim 18, wherein the factory enhancement module disables the alarm state after a predetermined period, records an alarm condition, and goes back to the continual monitoring of the data bus interface of the factory enhancement module and the antenna interface.

21. The two-way automotive remote control system of claim 17, wherein the factory enhancement module transmits the message to the remote, updates the vehicle status, and goes back to the continual monitoring of the data bus interface of the factory enhancement module and the antenna interface, on detecting the lock signal or the unlock signal along with the absence of the alarm signal, the opened door signal, or the opened hood signal.

22. The two-way automotive remote control system of claim 1, wherein the wire harness comprises a three-wire harness including leads for data bus, power, preferably DC 12V, and electrical ground.
